(19) United States
(12) Patent Application Publication
(10) Pub. No.: US 2022/0347506 A1
(43) Pub. Date: Nov. 3, 2022

(54) System and Method for Fire Fighting in a Room, in Particular in a Residential Room

(71) Applicant: Minimax Viking Research & Development GmbH, Bad Oldesloe (DE)

(72) Inventors: Klaus HOFMANN, Bad Oldesloe (DE); Joachim BÖKE, Bad Oldesloe (DE)

(21) Appl. No.: 17/261,861

(22) PCT Filed: Jul. 26, 2019
(86) PCT No.: PCT/EP2019/070240

§ 371 Date: Jan. 20, 2021

(30) Foreign Application Priority Data
Jul. 27, 2018 (DE) 10 2018 118 301.1

(51) Int. Cl. A62C 37/40

(52) U.S. Cl. CPC A62C 37/40

(57) ABSTRACT

The present invention relates to a system (1) and a corresponding method (400) for fire fighting of a room (101) comprising one or more fire locator devices (7) comprising an array sensor (19) having a grid (17) of sensor elements each; a controller (9) that associates each of the sensor elements of the array sensor (19) to at least one zone (210a-210e, 310a-310h); a plurality of controllable fire fighting devices (3a-3e) being arranged to selectively release a supply of fire extinguishing fluid to one of the plurality of zones (210a-210e, 310a-310h) upon activation by the controller (9).

The present application relates to a system and corresponding method for fire fighting of a room. The present invention applies particularly, without being limited, to the field of residential fire fighting.

A residential sprinkler according to the definition provided in UL 1626 is a sprinkler intended to be installed in residential occupancies and that opens automatically by operation of a heat-responsive releasing mechanism that maintains the discharge orifice closed. Upon operating at a specified temperature, a discharge of water is distributed in a specific pattern and quantity over a designated area.

Residential sprinklers are thus actuated by heat and usually discharge excess fire extinguishing fluid, in particular water, to regions of the protected room far away from the source of the fire, which leads to severe damage caused by water.

WO 2015/092691 A1 discloses a fire detection system, which includes at least two fire detectors having a partially overlapping view of a fire. The at least two fire detectors are configured to acquire fire cluster information related to the fire. A validation and pairing module pairs fire clusters detected by the at least two fire detectors for the fire. The validation and pairing module is configured to validate the paired fire clusters according to a validation process that ensures that the pair corresponds to a fire. A triangulation module determines a three-dimensional fire location for the fire based on the fire cluster information related to the validated fire cluster pairs.

JP 200104654 A discloses a movable spraying head, which mounts a flame sensor and an IR linear sensor, wherein the flame sensor and the IR linear sensor are disposed in a sprinkling/scattering region within rotary locus of the spraying head and whose directional line differs from the spraying head.

The article from WIKIPEDIA “Flame Detector” of 10 Apr. 2018 describes a flame detector, which is a sensor designed to detect and respond to the presence of a flame or fire, allowing flame detection. Responses to a detected flame depend on the installation, but can include sounding an alarm, deactivating a fuel line (such as a propane or a natural gas line), and activating a fire suppression system.

It has therefore been an object of the present invention to provide a system and corresponding method for fire fighting of a room, in particular of a residential room, which can reduce the risk of damages caused by water as in classical residential sprinkler systems.

According to a first aspect a system for fire fighting of at least a part of a room, in particular of a residential room, is provided. The system comprises one or more fire locator devices mounted on at least one of a wall and a ceiling of the room, each of the fire locator devices comprising an array sensor having a grid of sensor elements; a controller that associates each of the sensor elements of the array sensor to at least one zone of the room, the at least one zone being one of a plurality of zones, each of the plurality of zones comprising at least one of floor surface and wall surface of the room; and a plurality of controllable fire fighting devices mounted on at least one of the wall and a ceiling of the room, each of the fire fighting devices being arranged to selectively release a supply of fire extinguishing fluid to one of the plurality of zones upon activation by the controller.

The controller is configured to determine the presence of a fire in at least one of the zones responsive to a signal from the array sensor, to identify a fire fighting area in the at least one of the zones in which the fire is present, and to control the plurality of fire fighting devices to provide fire extinguishing fluid to the fire fighting area.

Since the system comprises at least one fire locator device, which is configured to determine a fire in one or more of a plurality of zones of the room, a more precise determination of a location of a fire can be achieved. Since further the system comprises controllable fire fighting devices, a fire fighting region, which is defined as the portion of the room to which fire fire extinguishing fluid is provided, can be accurately determined. In particular, not the entire room but only the zones of the room, in which the fire is determined, are provided with fire extinguishing fluid. Thus, it can be avoided to cause additional damage due to fire extinguishing fluid being provided to zones, which are not affected by the fire.

A zone of a room refers to a portion of the room, which can be defined as either a two-dimensional portion of the floor or wall surface or a three-dimensional portion of the volume of the room, comprising at least one of floor surface and wall surface.

In the present disclosure, the determination of a fire can differ from the detection of fires as described in the art. While the determination of a fire can simply consist in obtaining a location, e.g. in a particular zone of the room, in which a fire is likely to be present, the detection of fires implies the positive verification that a fire is indeed present. However, the detection of fires does not require a localisation of the fire.

It is a particular effect of the present invention that a fire can be precisely located, using the array sensor having a grid of sensor elements, such that the fire fighting area can be accurately fitted to the position, at which the fire is determined. Additionally, due to the arrangement of controllable fire fighting devices, an efficient controllable and reliable provision of fire extinguishing fluid to the fire fighting area can be obtained. In particular, since the floor surface and optionally also the wall surface, i.e. side wall or inclined wall surfaces and/or even ceilings of the room, can be provided with the adequate amount of fire extinguishing fluid, a reliable fire fighting of the fire can be ensured.

Controllable fire fighting devices according to the present invention are fire fighting devices, which are capable of discharging fire extinguishing fluid upon a control signal or trigger signal by the controller. For instance, the fire fighting devices can comprise one or more of controllable nozzles or sprinkler bulbs having an electrical triggering element. In the following, the terms controllable fire fighting devices and controllable nozzles or sprinklers are used interchangeably and should likewise cover all instances of fire fighting devices, that are controllable by the controller, i.e. can at least be activated by initiation of the controller.

The fire fighting devices can be directly or indirectly mounted on the wall or ceiling, i.e. the fire fighting devices can be provided within one or a plurality of housings, wherein the housing is then mounted on the wall or ceiling, respectively. Preferentially, the fire fighting devices and the fire locator device are provided within a single housing which is then mounted on the wall. Thus, a convenient installation of the system according to the invention is ensured.

In a preferred embodiment, the fire fighting devices can be activated and further be deactivated by a controller. Even more preferably, the fire fighting devices can be activated and deactivated a plurality of times. Classical sprinklers differ from these controllable fire fighting devices in that they are activated by heat only and do not have a means, for instance a valve, which allows them to be opened and/or closed once activated. By providing the plurality of controllable nozzles, a selective activation of one or more of the provided nozzles to direct the fire extinguishing fluid to the fire fighting area can be obtained.

Even further, controllable fire fighting devices can preferably be arranged and oriented to have a more suitably adapted sprinkler pattern than classical sprinkler nozzles. This can further reduce the impact of excess fire extinguishing fluid to zones or portions of the room, which are not affected by the fire.

In a preferred embodiment, the plurality of fire fighting devices is arranged and oriented such that any square meter of floor surface in the fire fighting area is provided with at least 0.4 (l/m²)/min (at least 0.01 US gallon per minute (gpm) per square feet (sqf), i.e. 0.01 gpm/sqf) of fire extinguishing fluid. Expressed differently, this value corresponds to 0.4 liters impinging per minute per square meter, that is a water column of at least 0.4 mm height impinges per minute. Preferably, the amount of fire extinguishing fluid per square meter of floor surface is at least 0.8 (l/m²)/min (at least 0.02 gpm/sqf). Thereby, a reliable and efficient fire fighting can be performed while requiring an amount of fire extinguishing fluid which does not exceed and is even less than the amount indicated in UL 1626.

In a preferred embodiment, the plurality of fire fighting devices is further arranged and oriented such that a wall surface of the fire fighting area is wetted within at least 30 cm from the floor of the room at the respective location of the wall surface. Thus, areas of the wall surface which are prone to significant heat impact due to, for instance, a fire are adequately wetted in order to assist the fire fighting process.

In a preferred embodiment the array sensor is sensitive to electromagnetic radiation, further preferably to at least one of infrared light, visible light and ultraviolet light. In the context of this disclosure, infrared light is understood to comprise electromagnetic radiation of a wavelength range between 700 nm and 1 mm, visible light is understood as the wavelength range between 500 and 700 nm and ultraviolet light is understood as electromagnetic radiation falling within a wavelength range between 10 and 400 nm.

In a preferred embodiment the plurality of controllable fire fighting devices is designed to collectively cover all zones of at least the part of the room such that: any square meter of floor surface can be provided with at least 0.4 (l/m²)/min of fire extinguishing fluid. Preferentially, additionally any wall surface can be wetted within at least 30 cm from the floor of the room of the room at the respective location of the wall surface. Thereby, conformity of the system with fire fighting performance standards, in particular the relevant norm UL 1626 for residential sprinklers, can be obtained.

In a preferred embodiment each of the plurality of fire fighting devices is operable to provide one particular zone of the room with fire extinguishing fluid. The discharge pattern of each of the respective fire fighting devices is thus preferentially matched with the respectively corresponding zone. For instance, a suitable deflection means for deflecting the fire extinguishing fluid into the desired shape can be provided, while also other suitable solutions, such as specifically adapted fire fighting devices, are contemplated.

Further preferably, the controller is configured to activate at most two of the plurality of fire fighting devices. Thus, the amount of deployed fire extinguishing fluid can be reduced. In reverse conclusion, the controller is preferably configured to determine the fire fighting area to comprise at most two zones.

Thus, a one-to-one correspondence between nozzles and zones can be established. Advantageously, since the discharge pattern of the nozzles and the zone respectively corresponding thereto is known, a more efficient fire fighting can be achieved. For instance, by selectively activating or deactivating one or more of the nozzles, fire extinguishing fluid can be provided precisely to the zone or the zones corresponding to the activated/deactivated nozzles.

In a preferred embodiment the number of the plurality of fire fighting devices is equal to or lower than the number of the plurality of zones.

In case the number of nozzles is equal to the number of zones, a one-to-one correspondence between nozzles and zones as described above, can be determined. Reducing the number of nozzles to the needed amount assists in keeping the costs of the system according to the disclosure to a minimum. In case further the number of nozzles is reduced below the number of zones allows to more accurately determine the zones due to the higher resolution, while not increasing the costs due to a provision of more nozzles. In this embodiment, preferably each of the nozzles which are assigned more than one zone are steerable so as to discharge fire extinguishing fluid to one of the plurality of zones, to which they are respectively assigned. Even more preferably, the plurality of zones, to which a single nozzle is assigned in this embodiment, are not adjacent zones, but have a different zone assigned to a different nozzle line in-between. Thus, a situation can be avoided, in which both zones, which are adjacent to each other, would be part of the fire fighting area and would require the same controllable nozzle to be activated. Expressed differently, it can be ascertained that two adjacent zones, forming an fire fighting area, can always be activated by activating two controllable nozzles.

In a preferred embodiment a number of sensor elements of the array sensor is higher than a number of the plurality of zones, in particular the number of sensor elements is higher than the number of the plurality of zones by a factor of at least twelve, preferably of at least 27.

The factor of approximately twelve can for instance correspond to an array of sensor elements of 8×8 pixels, wherein the number of zones can then correspond to approximately five. Other examples comprise the use of three adjacently arranged arrays of 8×8 pixels each, while the number of zones exemplarily also corresponds to five or, in case of a larger room, to seven, of course without being limited. While the array sensor in this embodiment still has a much lower resolution then, for instance, a CCD camera or high resolution IR-camera and the like, it allows at a significantly lower cost to keep the risk for falls alarms due to more functioning of one or more of the individual sensor elements to a minimum. More specifically, since each zone is imaged by approximately 12 or at least 27 sensor elements, respectively, a very high statistical reliability can be achieved.

In a preferred embodiment the array sensor comprises a thermopile array having an array of thermophile elements.

A thermopile array is a particularly beneficial selection for the array sensor due to its high liability and a fallible cost. Since the thermopile elements of the thermopile array generate a voltage proportional to the incurring radiation, in particular incurring infrared radiation, a very simple processing of the signal output of the thermopile elements is possible. Thus, overall complexity of the system is capped reasonable.

In a preferred embodiment the thermopile array comprises an array of eight times eight thermopile elements, wherein the number of the plurality of zones is less than the number of thermopile elements, wherein the number of the plurality of zones is in particular four to eight.

Of course, also higher or lower numbers of thermopile elements and/or zones are contemplated. Even further, it is contemplated to provide two or more thermopile arrays in one single room, wherein the two or more thermopile arrays can operate cooperatively or individually.

In a preferred embodiment the array sensor comprises at least three thermopile arrays arranged adjacently to each other, each comprising an array of eight times eight thermopile elements. Thus, a larger angle of view, for instance imaging a larger room, can be achieved.

In a preferred embodiment the controller is configured to associate each of the sensor elements of the array sensor to at least one of the zones so that at least two zones overlap. Since at least two zones overlap, a risk of insufficient coverage, particularly at the edges between two zones, can be reduced. Further, inaccuracies related to the definition of the zones have less impact.

In a preferred embodiment at least two adjacent zones out of the plurality of zones partially overlap at their edges, respectively.

Preferentially, in case adjacent zones overlap at their edges, a fire being determined in the overlapping portion of the adjacent zones can result in both of the adjacent zones being designated as the fire fighting area. It can thus be avoided that a fire being present at or near by an edge be insufficiently extinguished by activating both of the adjacent zones. Further, even in case one of the controllable nozzles does not have a completely uniform discharge pattern of fire extinguishing fluid, e.g. a fluid flow is less near the edge of the zone covered by the respective nozzle, as a sufficient fluid flow of fire extinguishing fluid even for fires occurring at or near an edge of the respective zones can be guaranteed.

In a preferred embodiment at least one zone of the plurality of zones entirely overlaps one or more of the other zones of the plurality of zones. The zone entirely overlapping one or more of the other zones can be regarded a redundant zone, which is advantageous to activate in case the fire is detected far away from the centers of those zones, which are overlapped by the overlapping zone. It is thus not necessary to provide fire extinguishing fluid to areas far away from the detected fire by adding the overlapping zone to the fire fighting area. Accordingly, a risk of damaged to be access fire extinguishing fluid can be reduced.

In a preferred embodiment the room floor is distributed among four adjacent zones of the plurality of zones. A fifth zone of the plurality of zones is located in a central area of the room, overlapping a portion of each of the first to fourth zone of the plurality of zones. In a further preferred embodiment, also at least part of the wall surface is additionally distributed among the zones.

In a preferred embodiment a surface area of each of the plurality of zones is approximately equal. Thus, assuming that a fluid flow through each of the controllable fire fighting devices covering the fire fighting area is approximately equal, also the fluid flow to each portion of the respective zones is approximately equal. Thus, a homogeneous fluid supply to each portion of the room can be assured.

Preferentially, the surface area comprises a floor and a wall surface area. In some embodiments, the floor area can be given a higher weight, i.e. the calculation of the total area to be provided with fire extinguishing fluid of each zones can be biased towards the floor area. Thus, for example, a need for more fluid flow to the floor surface as compared to the wall surface per surface area can be implemented.

In a preferred embodiment the grid of sensor elements of the array sensor defines a pixel matrix. The controller is configured to determine a transformation between the pixel matrix and the plurality of zones.

The transformation, which could also be referred to as a mapping between pixel matrix and plurality of zones, thus ascertains a correspondence between pixels of the pixel matrix defined by the sensor elements of the array sensor and the zones of the room. The transformation can be determined by the controller using input from the user and/or relying on a predefined configuration. The predefined configuration can take, for instance, geometrical details of the covered room into consideration.

In a preferred embodiment the controller is configured to determine the transformation under consideration of at least one of a spatial angular resolution of the sensor elements of the array sensor, a field of view of the array sensor and a location of the array sensor in the room. Thus, also a distance, angle and other distortion, which effect the field of view of the array sensor with respect to the room are considered.

In a preferred embodiment the controller is configured to determine a non-linear surjective transformation as the transformation between the pixel matrix and the plurality of zones.

The transformation is preferentially non-linear since a single pixel of the pixel matrix can have multiple correspondences, i.e. can correspond to a plurality of the zones, such as in case the zones overlap. Further, the transformation is preferentially surjective, since all of the zones are required to have at least one pixel out of the pixel matrix to be mapped onto or associated with the zone. Expressed differently, it is required to have all of the zones covered by at least one of the pixels of the pixel matrix.

In a preferred embodiment the system further comprises at least one fire detection device, in particular at least one fire detection device selected from the list consisting of smoke detector, in particular optical beam smoke detector or aspiration smoke detector; flame detector, in particular IR flame detector, UV flame detector or combined IR/UV flame detector; heat detector; gas detector; or multi-sensor-detector. The controller is configured to control the plurality of fire fighting devices to only provide fire extinguishing fluid to the fire fighting area in case the fire detection device determines the fire.

The fire detection device can thus determine the presence or non-presence of a fire. The fire detection device not necessarily allows for any spatial resolution, i.e. does not need to be able to provide the location of the fire, while is enough for the fire detection device to detect whether the fire is present or not. Thus, in this embodiment, the detection by the fire detection device presents a requirement for the controller, while the controllable fire fighting devices are only controlled to provide fire extinguishing fluid in case the fire detection device detects the presence of the fire in the room.

In a further aspect a method for fire fighting of at least a part of a room, in particular of a residential room, using a system is provided. The system comprises one or more fire locator devices mounted on at least one of a wall and a ceiling of the room, each of the fire locator devices comprising an array sensor having a grid of sensor elements; a controller; and a plurality of controllable fire fighting devices mounted on at least one of the wall and a ceiling of the room, each of the fire fighting devices being arranged to selectively release a supply of fire extinguishing fluid to one of the plurality of zones upon activation by the controller.

The method comprises operating the controller to: associate each of the sensor elements of the array sensor to at least one zone of the room, the at least one zone being one of a plurality of zones, each of the plurality of zones comprising at least one of floor surface and wall surface of the room; determine the presence of a fire in at least one of the zones responsive to a signal from the array sensor; identify a fire fighting area in the at least one of the zones in which the fire is present; and control the plurality of controllable fire fighting devices to provide fire extinguishing fluid to the fire fighting area.

The method achieves the same advantages as the system described above and can be advantageously adopted to and combined with any of the preferred embodiments described with reference to the system above.

Hereinafter, preferred embodiments of the invention will be described with reference to the accompanying drawings in greater detail.

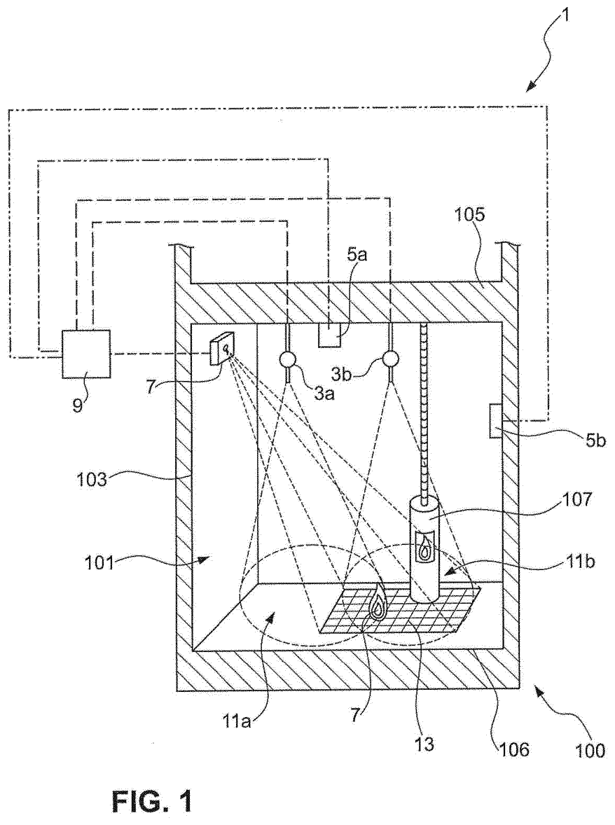

FIG. 1 shows a schematic view of a fire fighting system according to a preferred embodiment,

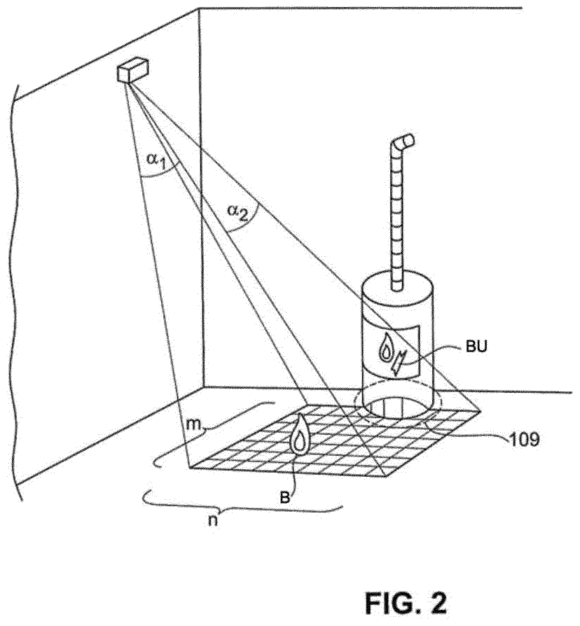

FIG. 2 a schematic detail view of the system according to FIG. 1,

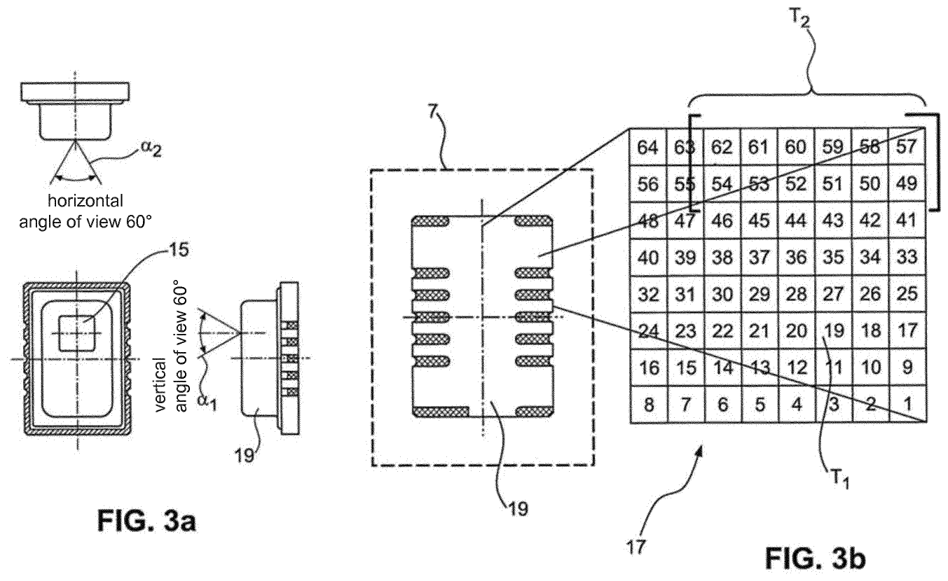

FIG. 3 a, b a schematic detail view of an array sensor used in the system of FIGS. 1 and 2,

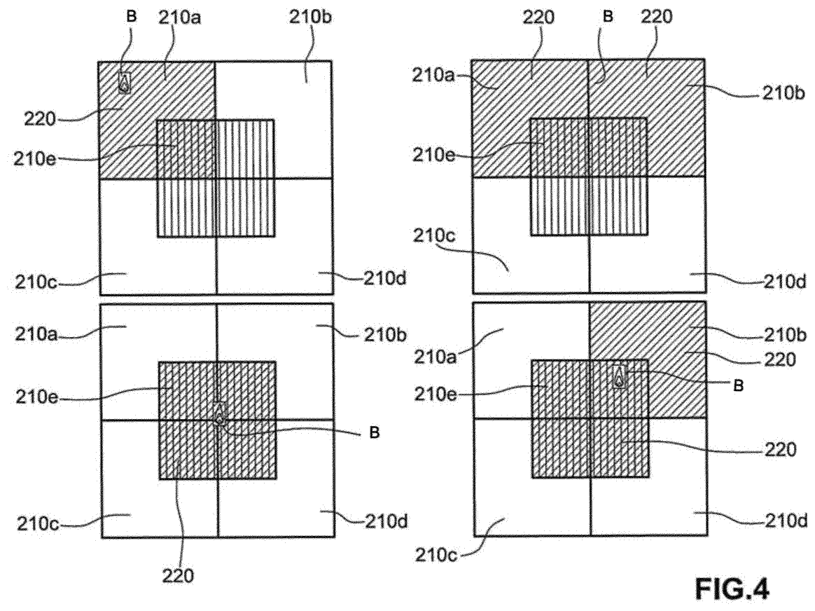

FIG. 4 a schematic view of a first example of zones in a room,

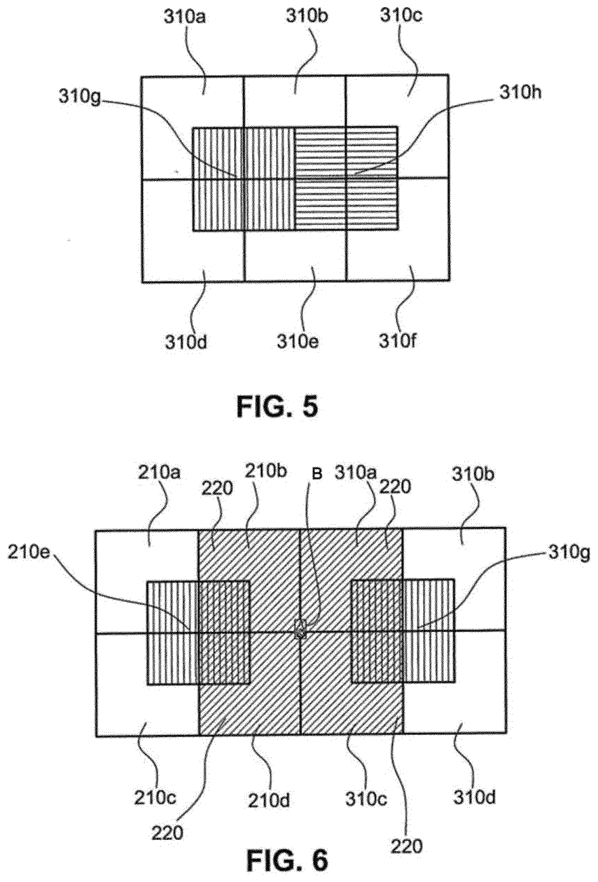

FIG. 5 a schematic view of a second example of zones in a room,

FIG. 6 a schematic view of a third example of zones in a room,

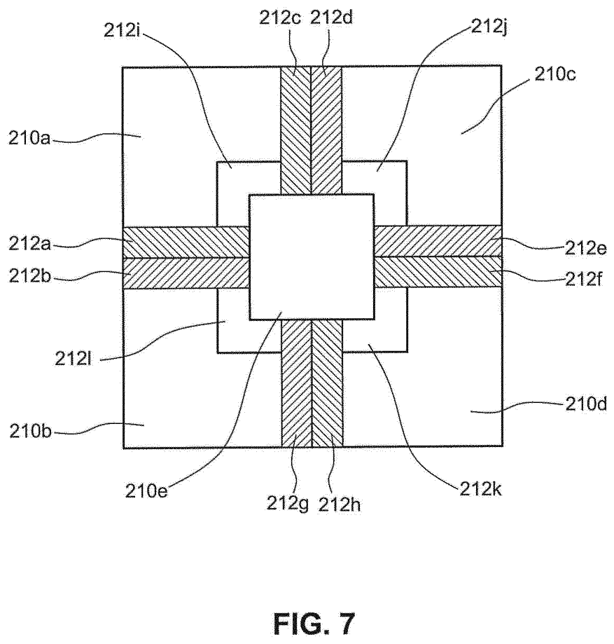

FIG. 7 a schematic view of a fourth example of zones in a room,

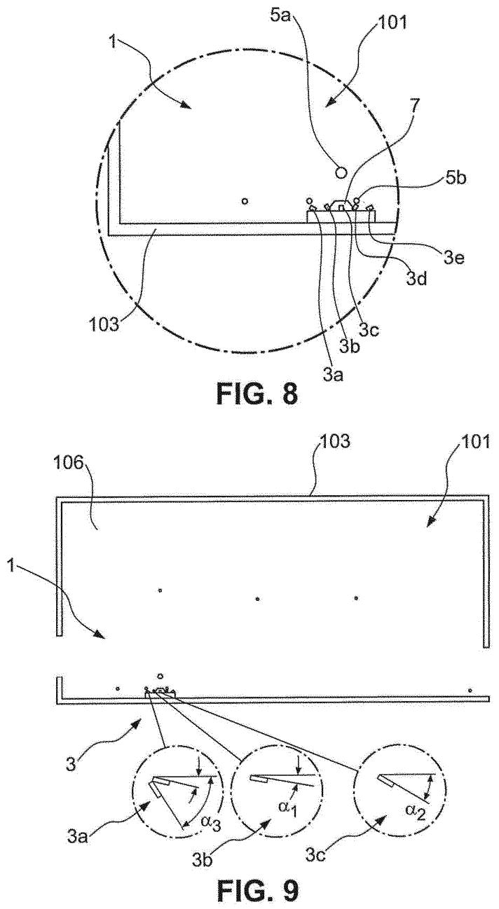

FIG. 8 a schematic detail view of a fire fighting system,

FIG. 9 a schematic view of the system of FIG. 8 in a room, and

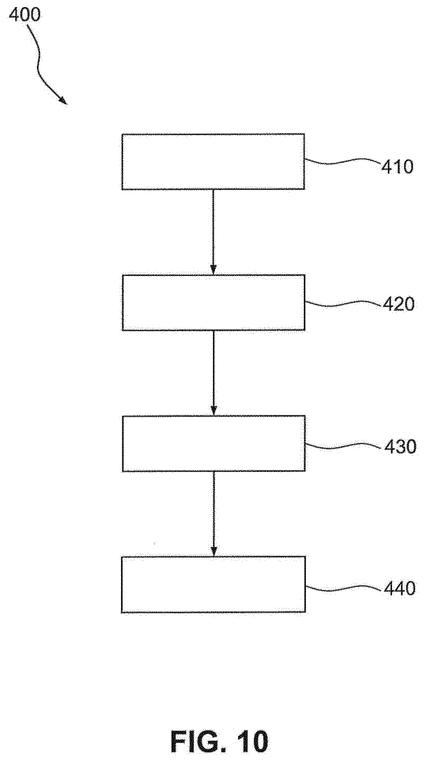

FIG. 10 schematically and exemplarily a flow chart of a method for fire fighting of a room.

FIG. 1 shows a fire fighting system 1. The fire fighting system 1 is installed in a room 101 of a building 100. The room comprises a number of side walls 103, a ceiling 105 and a floor 106. Inside the room 101, a heat source 107 is installed.

It should be noted that, while an entire room 101 is illustrated in FIG. 1 and some of the consecutive figures, the system according to the invention can also be provided to protect only a part of the room. In this case, also a plurality of systems 1 according to the invention can be provided to protect the entire room. Thus, a room according to this invention is used as a defined space under protection by fire fighting system 1, which can also be a part of a physical room, i.e. a construction being enclosed by walls and ceiling.

The system 1 comprises a number of fire fighting devices 3a, b which are installed for example under the ceiling 105 of the room 101, but could alternatively also be wall-mounted. The fire fighting devices 3a, b may for example be open fire fighting nozzles of a deluge system.

The system 1 further comprises a plurality of fire detection devices 5a, b installed in the room 101, for example under the ceiling 105 and/or on one of the side walls 103. While a plurality of fire detection devices 5a, b is illustrated in FIG. 1, it should be noted that also a single fire detection device is sufficient in other examples.

The system 1 further comprises a fire locator device 7 that is configured to locate a fire F in the room 101. The fire detector devices 5a, b are configured to detect the presence of a fire in the room 101. The fire fighting devices 3a, b are each positioned such that they distribute fire extinguishing fluid within a respective coverage zone 11a, b (hereinafter also “zone”) of the room 101. The zones 11a, b may overlap.

System 1 further comprises a controller 9 which is in signal communication with the fire fighting devices 3a, b with the fire detection devices 5a, b and with the fire locator device 7. The controller 9 is configured to activate the fire fighting devices 3a, b in reaction to a detection of the fire F as is detailed further herein below.

The fire locator device 7 comprises an array sensor 19 (FIGS. 3a, b) which has a defined field of view having a first view angle α1 and a second view angle α2 (FIG. 2). Within its field of view, the array sensor 19 is adapted to monitor a predetermined area, or zone, of the room 101. The array sensor 19 comprises a sensor array 15 having a plurality of n×m pixels arranged in a grid 17. Since the fire locator device 7 is stationary, i.e. fixedly installed in the room 101, once oriented, each of the pixels of the grid 17 is specifically assigned to a specific portion of the room 101. Depending on the distance of the fire locator device 7 from e.g. the floor 106 of the room 101 and depending on the specific view angles α1, α2, the grid 17 of pixels defines a projection 13 of the pixel grid 17 in the room 101. A fire F which lies within this projection 13 will be determined by the grid 17 of the sensor array 15.

Preferably, the sensor array 15 is an infrared sensor array, in particular a thermopile array. The array sensor 19 is configured to generate for each pixel a signal representative for a temperature within the portion of the projection 13 in the room 101. The fire F will cause representative temperature signals to be generated by the array sensor 19. The controller 9 is configured to receive the representative temperature signals from the array sensor 19.

Also, the controller 9 is configured to allocate specific threshold values T₁, T₂ to each pixel of the sensor array 15. There may be two or more different threshold values used across the array. According to the invention, it is possible to designate a threshold value that will be reached only in case of a fire, or not be reached at all, the latter being especially useful to permanently “blind” the array sensor from certain stationary hot spots that are indicative of non-fire related heat sources.

However, each threshold value may also be indicative of a temperature limit, the breach of which happens only in case of a fire in that specific portion of the room. As soon as the temperature in the pixels of the sensor array 15 exceeds the predetermined threshold levels T₁, T₂ indicative of a fire, the controller not only has identified the presence of a fire F in the room 101, but additionally has located the portion within the projection 13 where the fire F recites by identifying the respective hot spot among the grid 17 of pixels. This allows for very efficient allocation of the fire fighting device 3a or 3b that is ideally positioned to distribute fire extinguishing fluid in the zone where the fire F has been located. Depending on whether the fire has been located in a zone that is overlapped by the zones 11a, b covered by a plurality of fire fighting devices 3a, b, the controller 9 may also activate more than one fire fighting device 3a, b, but ideally no more than two fire fighting devices 3a, b.

In many rooms, in particular residential rooms, it is to be expected that stationary heat sources such as heat source 107 are present in a portion monitored by the fire locator device 7. In order to prevent false fire alarms, and in order to prevent inaccurate location of actual fires due to the influence of stationary heat sources, the controller 9 is configured to assign specific threshold values T₂ to all pixels which are within range of the stationary hot spot 109 formed by the stationary heat source 107. As is depicted in FIG. 2 and FIG. 3b, the controller 9 could for example be programmed to assign a higher threshold value T₂ to pixels 49 through 54 and 57 through 62, while assigning a lower threshold value T₁ to the remaining pixels of the grid 17. By doing so, increased temperatures emanating from heat source 107 would not be flagged as hotspots indicative of a fire F, unless the predetermined higher threshold value T₂ is exceeded.

This allows the controller 9 to distinguish between a fire F and a fire-unrelated heat source NF. Basically, any number of stationary heat sources may be accounted for in this way.

While the embodiments of FIGS. 1 through 3b show a simple set-up of a room 101 having only one fire locator device, the invention also covers embodiments wherein the room 101, either due to its size or due to its complexity of its layout, requires the use of more than one fire locator device. Preferably, the entire floor 106 of the room is covered by grids 17 of pixels emanating from specifically mounted and oriented fire locator devices 7. Depending on economic factors and ease of installation, the number of fire locator devices for the size of the grid 17 of pixels for each fire locator device 7 may be modified according to need. At any rate, the invention allows for the use of array sensors 19 having sensor arrays 15 with comparatively low resolution (in particular when compared to prior art systems using high-res infrared camera systems).

FIGS. 4 to 7 schematically and exemplarily illustrate different configurations or distributions of zones 210a-210e or 310a-310h in different rooms, respectively.

FIG. 4 illustrates a layout of four zones 210a-210d, which are equal in size and apportion the surface area of the room among them. In other words, the four zones 210a-210d cover the entire surface area, i.e. the floor and—if necessary—at least part of the wall surface area of the room. A further, fifth zone 210e is located in the center of the room and overlays all of the other four zones in the center of the room. Fifth zone 210e is thus redundant and provided to limit the spacial extension and also the amount of the fire extinguishing fluid dispersion.

In FIG. 4, four examples of a fire F at different locations within the illustrated room, i.e. within different zones 210a-210e, are illustrated. Each of the examples of the fire F leads to the determination of an fire fighting area 220 by the controller 9, which is as follows. In the first example, since the fire F is located within zone 210a, the fire fighting area is determined to be comprised of zone 210a. In the second example, the fire F is located at the edge between zone 210a and zone 210b, such that both zone 210a and zone 210b are determined as the fire fighting area 220. The third example shows the fire F in the center of the room.

In this example, only zone 210e is determined as fire fighting area 220. In the last example, the fire F is located close to the center within zone 210b. Thus, both the central zone 210e and zone 210b are determined as fire fighting area 220. In these examples, for the reasons discussed above, it is preferred that not more than two zones 210a-210e be determined as fire fighting area 220.

In this example, both the room and each of the respective zones 210a-210e are of quadratic shape for the ease of illustration, while of course also different examples of shapes are contemplated. The quadratic shape is particularly beneficial in combination with specific controllable nozzles as fire fighting devices, e.g. fire fire fighting device 3a-3e, such as a Viking Model A full cone nozzle or a similarly operating, publically available nozzle.

FIG. 5 substantially corresponds to the example of FIG. 4, wherein the room—or likewise a part of the room—is rectangular and its surface is distributed among six zones 310a-310f, which are also in this example quadratic and of equal size. Two central zones 310g and 310h are respectively provided to overlap four adjacent of the zones 310a-310f, respectively. The determination of a fire fighting area 220 is performed analogous to the example of FIG. 4. In other word, not more than two zones 310a-310h are determined to be part of the fire fighting area (not shown in FIG. 5) at the time.

FIG. 6 schematically illustrates a further example, wherein the room is split into two substantially independent regions of five zones 210a-210e, 310a-310d and 310g, respectively. For examples, each of the two groups of five zones can be coordinated and controlled by a particular, individual controller 9 and/or fire locator device 7. In other examples, the two groups can also be controlled commonly by a single controller 9 and/or fire locator device 7.

In the example of FIG. 6, the two fully overlapping regions 210e, 310g are not adjacent to each other, different from the example of FIG. 5, in which two completely overlapping zones 310g, 310h are adjacent to each other. In the example of FIG. 6 a fire F is illustrated in the center of the room. In this example, the fire fighting area 220 is extended to include two zones 210b, 210d, and 310a, 310c of each of the first and second group of zones 210, 310, respectively.

Accordingly, in this example also the situation, in which more than two zones are comprised in the fire fighting area 220 is illustrated. The example of FIG. 6 is particularly useful in case two substantially independent systems for fire fighting are arranged in the same room. In this case, two zones per independent system are comprised in the fire fighting area 220, respectively. Then, again, not more than two zones will be activated concurrently, i.e. designated as the fire fighting area 220

It is of course contemplated that also in the example of FIG. 6 a further fully overlapping zone can be defined in between the zones 210e and 310g. In this particular case, it would be beneficial to protect the entire room as illustrated in FIG. 6 with a single system for fire fighting according to the invention.

FIG. 7 schematically and exemplarily illustrates the effect of overlapping zones in the example of five zones 210a-210e. In this example, overlapping regions 212a-212k are formed in the overlapping area between two adjacent zones 210a-210e, respectively.

Overlapping regions 212a and 212b correspond to the region in which zone 210a overlaps zone 210b and vice versa. Accordingly, the fire fighting area 220 in case a fire F is detected in either region 212a or region 212b will be comprised of both zone 210a and 210b. Likewise, in overlapping regions 212c and 212d zones 210a and 210c will form the fire fighting area 220. A fire F in overlapping region 212e or 212f will yield a fire fighting area 220 with zones 210c and 210d, while a fire F in overlapping region 212g or 212h will result in fire fighting area 220 being formed of zones 210b and 210d.

Finally, in case a fire is present in the outer region of zone 210e, i.e. the region near the edge of zone 210e, which are indicated with 212i, 212j, 212k or 212l, the fire fighting area 220 is formed of zone 210e and one of zones 210a-210d, respectively. Thus, also in this example with overlapping regions, it can be ensured that not more than two zones will be comprised in the fire fighting area 220 at the same time.

FIG. 8 and FIG. 9 schematically and exemplarily illustrate a further example of the system 1 according to, for example, FIG. 1. In FIG. 8, it can be particularly seen that a fire locator device 7 is mounted at or on the side wall 103 or the room 101

The fire locator device 7 comprises, not shown in detail, the array sensor 19. Further, in this example, fire locator device 7 is mounted together with five controllable nozzles, i.e. fire fire fighting devices 3a, 3b, 3c, 3d, 3e. Preferentially, at least the fire fighting devices 3a, 3b, 3c, 3d, 3e and the fire locator device 7 are mounted on or in a single housing, while in other examples also at least two housings can be provided for the respective components. Each of the five fire fighting devices 3a, 3b, 3c, 3d and 3e can be corresponded to, for instance, one of five zones, respectively.

Finally, two additional fire detection devices 5a, 5b are provided. The location of the fire detection devices 5a, 5b is of course only an example and also different locations within the room 101 are contemplated.

In particular, fire detection device 5a, for instance a smoke detector, is illustrated near the center of room 101 and used as a double interlock safety feature, i.e. the fire fire fighting devices 3a-3e, 3c, 3d, 3e are only operated by controller 9 in case also at least one of the additional fire detection devices 5a and 5b detects a fire in the room 101. The second additional fire detection device 5b can also be a smoke detector or any other detector, which is preferentially arranged to detect a fire within the room 101. In contrast to fire detection device 5a, fire detection device 5b is mounted nearby fire locator device 7, thereby facilitating mounting of the entire system 1.

FIG. 9 illustrates the example of FIG. 8 in a different scale. In particular, it can be seen in FIG. 9 that different fire fire fighting devices 3a, 3b and even 3c are provided with a different orientation α1, α2, α3 with respect to the direction of side wall 103. The number of three fire fire fighting devices 3a, 3b, 3c is of course not limited and can be more or less than three. Further, also in the other examples illustrated above more or less fire fire fighting devices can be provided.

FIG. 10 schematically and exemplarily illustrates a flowchart of a method 400 for fire fighting of a room, such as room 101 discussed above, using system for fire fighting, such as system 1 discussed above.

The system 1 particular comprises one or more fire locator devices 7 mounted on at least one of a wall 103 and a ceiling 105 of the room 101. Each of the fire locator devices 7 comprises an array sensor, such as array sensor 19, having a grid 17 of sensor elements. The system further comprises a controller and a plurality of controllable nozzles as fire fire fighting devices 3a-3e, which are mounted on at least one of the wall 103 and ceiling 105 of the room 101. Each of the fire fire fighting devices 3a-3e is arranged to selectively release or stop a supply of fire extinguishing fluid to one of the plurality of zones 210a-210e, 310a-310h upon activation by the controller 9.

The method 400 comprises operating the controller 9 to carry out the following steps:

A step 410 of associating each of the sensor elements of the array sensor 19 to at least one zone 210a-210e, 310a-310h of the room 101, the at least one zone 210a-210e, 310a-310h being one of a plurality of zones 210a-210e, 310a-310h, each of the plurality of zones 210a-210e, 310a-310h comprising at least one of floor surface and wall surface of the room 101.

A step 420 of determining the presence of a fire F in at least one of the zones 210a-210e, 310a-310h responsive to a signal from the array sensor 19. Accordingly, the location of the fire F is determined in this step.

A step 430 of identifying a fire fighting area 220 in the at least one of the zones 210a-210e, 310a-310h in which the fire F is present. Based on the location of the fire F, which was determined in step 420, the fire fighting area 220 is thus identified.

A step 440 of controlling the plurality of fire fire fighting devices 3a-3e to provide fire extinguishing fluid to the fire fighting area 220 such that any square meter (m²) of floor surface in the fire fighting area 220 is provided with at least 0.4 (I/m²)/min of fire extinguishing fluid corresponding to at least 0.1 gpm/sqf. Preferably, before controlling the fire fighting devices 3a-3e to provide the fire extinguishing fluid, a fire detector, such as a smoke detector, is required to detect the presence of the fire-condition. Expressed differently, the fire detector detecting the fire is the requirement for the activation of any of the fire fighting devices 3a3e.

The present disclosure thus relates to a system 1 and a corresponding method 400 for fire fighting of a room 101 comprising one or more fire locator devices 7 comprising an array sensor 19 having a grid 17 of sensor elements each; a controller 9 that associates each of the sensor elements of the array sensor 19 to at least one zone 210a-210e, 310a-310h; a plurality of controllable fire fighting devices 3a-3e being arranged to selectively release a supply of fire extinguishing fluid to one of the plurality of zones 210a-210e, 310a-310h upon activation by the controller 9.

### LIST OF REFERENCE SIGNS

1 system
3a,b,c,d,e fire fire fighting device
5a,b fire detection device
7 fire locator device
9 controller
11a,b zone
13 projection of pixel grid
15 array
17 pixel grid
19 array sensor
100 building
101 room
103 side wall
105 ceiling
106 floor
107 heat source
109 stationary hot spot
210a-e zone
212a-l overlapping region
220 fire fighting area
310a-h zone
400 method for fire fighting
410 associating step
420 determination step
430 identifying step
440 control step
m, n grid parameters
F fire
NF fire-unrelated heat source
T₁, T₂ threshold
α₁, α₂, α₃ angle, field of view

1. A system for fire fighting of at least a part of a room of a residential room, comprising:
one or more fire locator devices mounted on at least one of a wall and a ceiling of the room, each of the fire locator devices comprising an array sensor having a grid of sensor elements;
a controller that associates each of the sensor elements of the array sensor to at least one zone of the room, the at least one zone being one of a plurality of zones, each of the plurality of zones comprising at least one of floor surface and wall surface of the room;
a plurality of controllable fire fighting devices mounted on at least one of the wall and a ceiling of the room, each of the fire fighting devices being arranged to selectively release a supply of fire extinguishing fluid to one of the plurality of zones upon activation by the controller;
wherein the controller is configured
to determine the presence of a fire in at least one of the zones responsive to a signal from the array sensor,
to identify a fire fighting area in the at least one of the zones in which the fire is present, and
to control the plurality of fire fighting devices to provide fire extinguishing fluid to the fire fighting area.

2. The system according to claim 1, wherein the plurality of fire fighting devices is arranged and oriented such that any square meter (m²) of floor surface in the fire fighting area is provided with at least 0.4 (l/m²)/min of fire extinguishing fluid.

3. The system according to claim 1, wherein the plurality of fire fighting devices is arranged and oriented such that a wall surface of the fire fighting area is wetted within at least 30 cm from the floor of the room at the respective location of the wall surface.

4. The system according to claim 1, wherein the plurality of fire fighting devices comprises at least one controllable nozzle.

5. The system according to claim 1, wherein the array sensor is sensitive to electromagnetic radiation.

6. The system according to claim 1, wherein the plurality of fire fighting devices is designed to collectively cover all zones of at least the part of the room such that: any square meter (m²) of floor surface can be provided with at least 0.4 (l/m²)/min of fire extinguishing fluid.

7. The system according to claim 6, wherein the plurality of fire fighting devices is further designed to collectively cover all zones of at least the part of the room such that a wall surface can be wetted within at least 30 cm from the floor of the room at the respective location of the wall surface.

8. The system according to claim 1, wherein each of the plurality of fire fighting devices is operable to provide one particular zone of the room with fire extinguishing fluid.

9. The system according to claim 1, wherein
the number of the plurality of fire fighting devices is equal to or lower than the number of the plurality of zones.

10. The system according to claim 1, wherein a number of sensor elements of the array sensor is higher than a number of the plurality of zones by a factor of at least twelve.

11. The system according to claim 1, wherein the array sensor comprises a thermopile array having an array of thermophile elements.

12. The system according to claim 11, wherein the thermopile array comprises an array of eight times eight thermopile elements, wherein the number of the plurality of zones is less than the number of thermopile elements, wherein the number of the plurality of zones is four to eight.

13. The system according to claim 12, wherein the array sensor comprises at least three thermopile arrays arranged adjacently to each other, each comprising an array of eight times eight thermopile elements.

14. The system according to claim 1, wherein the controller is configured to associate each of the sensor elements of the array sensor to at least one of the zones so that at least two zones overlap.

15. The system according to claim 14, wherein at least two adjacent zones out of the plurality of zones partially overlap at their edges, respectively.

16. The system according to claim 14, wherein at least one zone of the plurality of zones entirely overlaps one or more of the other zones of the plurality of zones.

17. The system according to claim 14, wherein the room floor surface is distributed among four adjacent zones of the plurality of zones, wherein a fifth zone of the plurality of zones is located in a central area of the room, overlapping a portion of each of the first to fourth zones of the plurality of zones.

18. The system according to claim 1, wherein a surface area of each of the plurality of zones is approximately equal.

19. The system according to claim 1, wherein the grid of sensor elements of the array sensor defines a pixel matrix, wherein the controller is configured to determine a transformation between the pixel matrix and the plurality of zones.

20. The system according to claim 19, wherein the controller is configured to determine the transformation under consideration of at least one of a spatial angular resolution of the sensor elements of the array sensor, a field of view of the array sensor and a location of the array sensor in the room.

21. The system according to claim 19, wherein the controller is configured to determine a non-linear surjective transformation as the transformation between the pixel matrix and the plurality of zones.

22. The system according to claim 1, further comprising at least one fire detection device selected from the list consisting of: smoke detector, optical beam smoke detector aspiration smoke detector; flame detector, IR flame detector, UV flame detector, combined IR/UV flame detector; heat detector; gas detector; or multi-sensor-detector,
wherein the controller is configured to control the plurality of fire fighting devices to only provide fire extinguishing fluid to the fire fighting area in case the fire detection device determines the fire.

23. A method for fire fighting of at least a part of a room, of a residential room, using a system comprising:
one or more fire locator devices mounted on at least one of a wall and a ceiling of the room, each of the fire locator devices comprising an array sensor having a grid of sensor elements;
a controller; and
a plurality of controllable fire fighting devices mounted on at least one of the wall and a ceiling of the room, each of the fire fighting devices being arranged to selectively release a supply of fire extinguishing fluid to one of the plurality of zones upon activation by the controller;
wherein the method comprises operating the controller to:
associate each of the sensor elements of the array sensor to at least one zone of the room, the at least one zone being one of a plurality of zones, each of the plurality of zones comprising at least one of floor surface and wall surface of the room;
determine the presence of a fire in at least one of the zones responsive to a signal from the array sensor;
identify a fire fighting area in the at least one of the zones in which the fire is present; and
control the plurality of fire fighting devices to provide fire extinguishing fluid to the fire fighting area.
